(19) United States
(12) Patent Application Publication
(10) Pub. No.: US 2007/0146650 A1
(43) Pub. Date: Jun. 28, 2007

(54) PROJECTION TYPE IMAGING APPARATUS AND PROJECTION TYPE IMAGING METHOD

(76) Inventor: Katsuhiro Mizushima, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/615,175

(22) Filed: Dec. 22, 2006

(30) Foreign Application Priority Data
Dec. 26, 2005 (JP) 2005-373401
Nov. 29, 2006 (JP) 2006-321973

(51) Int. Cl. G03B 21/28

(52) U.S. Cl. 353/99

(57) ABSTRACT

According to one embodiment, a projection type imaging apparatus has a mask processing section which applies a digital processing operation to a given digital image signal, and carries out a mask processing operation for the digital image signal, a light emitting section which irradiates light, a DMD section which irradiates light to a plurality of mirror units and controls the mirror units in response to a masked image signal from the mask processing section, thereby converting the light irradiated from the light emitting section to picture light responsive to the digital image signal, and projecting the converted picture light, and a screen section which receives the picture light from the DMD section, and displays a picture.

### CROSS-REFERENCE TO RELATED APPLICATIONS

This application is based upon and claims the benefit of priority from Japanese Patent Applications No. 2005-373401, filed Dec. 26, 2005; and No. 2006-321973, filed Nov. 29, 2006, the entire contents of both of which are incorporated herein by reference.

### BACKGROUND

1. Field

One embodiment of the invention relates to a projection type imaging apparatus, and particularly to a projection type imaging apparatus using a screen.

2. Description of the Related Art

As a projection type imaging apparatus, for example, in a projection television, a picture is projected on a screen. At this time, in this projection, a redundant portion at the periphery of the picture is often subjected to masking. In addition, masking is often carried out at a rear stage portion in the course of projecting the picture. For example, this rear stage portion is a cabinet portion to which the screen is attached.

Furthermore, as a middle stage portion, there is a system of providing an aperture in the vicinity of a lens through which light serving as a picture passes. For example, the invention disclosed in patent document 1 (Jpn. Pat. Appln. KOKAI Publication No. 5-157984 (refer to FIG. 8)) is directed to a system of providing an aperture in the middle of a plurality of lenses through which light passes.

However, there is a problem that if masking is carried out at a rear stage portion in the course of projecting the picture, there is a need for taking a mechanical and ineffective countermeasure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an external view showing an example of an appearance of a projection type imaging apparatus according to an embodiment of the present invention;

FIG. 2 is a block diagram depicting an example of an electrical configuration of a projection type imaging apparatus according to an embodiment of the present invention;

FIG. 3 is a flow chart showing an example of a mask processing operation of a projection type imaging apparatus according to an embodiment of the present invention;

FIG. 4 is an illustrative view showing an example of an optical path of light from a projection type imaging apparatus according to an embodiment of the present invention;

FIG. 5 is an illustrative view showing a relationship between a screen and a picture in the case where a mechanical distortion does not occur in a projection type imaging apparatus according to an embodiment of the present invention;

FIG. 6 is an illustrative view showing a relationship between a screen and a picture in the case where a mechanical distortion occurs in a projection type imaging apparatus according to an embodiment of the present invention;

FIG. 7 is an illustrative view showing a relationship between a screen and a picture when a case in which a picture shift due to a mechanical distortion and a picture over-scan portion occur has been adjusted by means of a picture phase adjusting and mask processing operations, in a projection type imaging apparatus according to an embodiment of the present invention; and

FIG. 8 is an illustrative view showing a relationship between a screen and a picture when a case in which no mechanical distortion occurs and a picture over-scan portion occurs has been adjusted by means of a mask processing operation, in a projection type imaging apparatus according to an embodiment of the present invention.

### DETAILED DESCRIPTION

Various embodiments according to the invention will be described hereinafter with reference to the accompanying drawings.

One embodiment of the present invention is to provide a projection type imaging apparatus and a projection type imaging method, for carrying out a required masking processing operation in the course of electrically processing an image signal.

One embodiment of the present invention is a projection type imaging apparatus comprising:

a mask processing section (19) which applies a digital processing operation to a given digital image signal, and carries out a mask processing operation for the digital image signal;

a light emitting section (21) which irradiates light;

a DMD section (22) which irradiates light to a plurality of mirror units and controls the mirror units in response to a masked image signal from the mask processing section, thereby converting the light irradiated from the light emitting section to picture light responsive to the digital image signal, and projecting the converted picture light; and

a screen section (2) which receives the picture light from the DMD section, and displays a picture.

In this manner, it becomes possible to apply a required mask processing operation at a stage of an electrical processing operation in response to the given digital image signal.

Now, a projection type imaging apparatus according to an embodiment of the present invention will be described in detail with reference to the accompanying drawings.

<Projection Type Imaging Apparatus According to an Embodiment of the Present Invention>

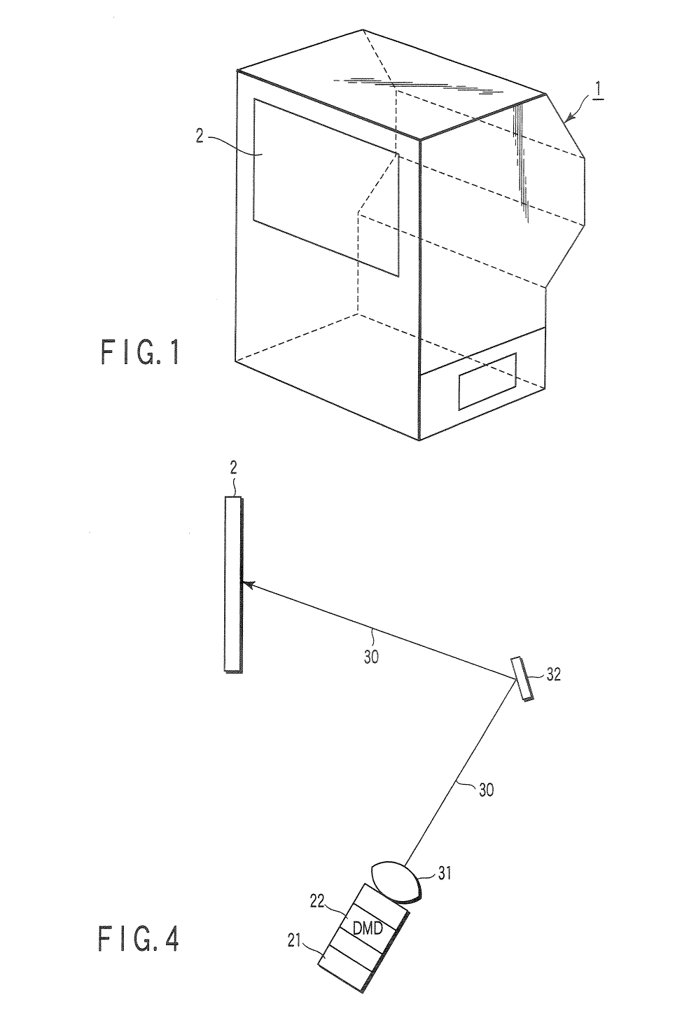

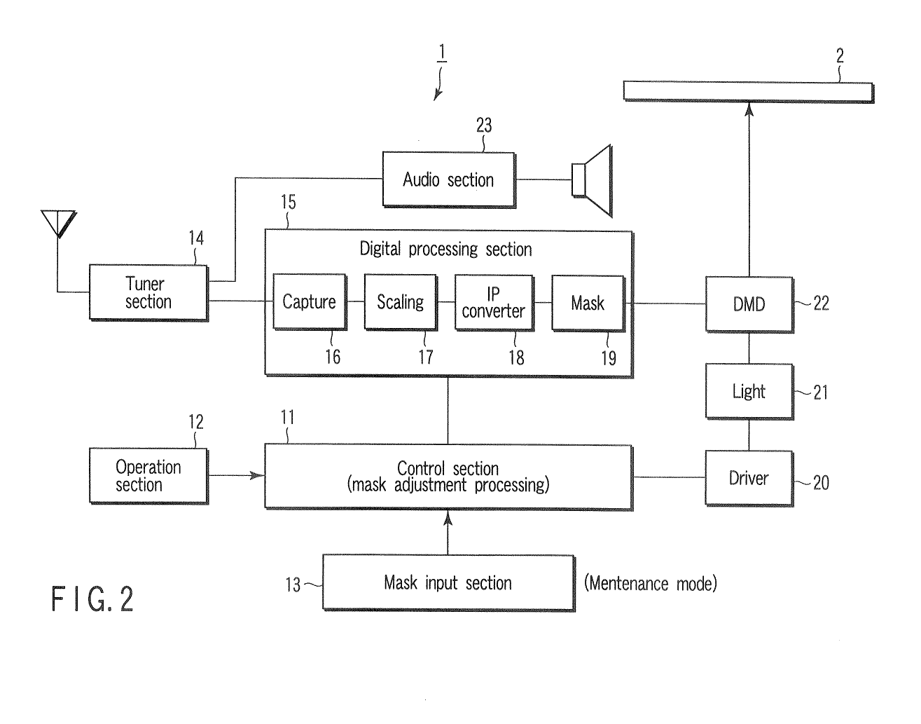

FIG. 1 is an external view showing an example of an appearance of a projection type imaging apparatus according to an embodiment of the present invention; and FIG. 2 is a block diagram depicting an example of an electrical configuration of a projection type imaging apparatus according to an embodiment of the present invention.

A projection type imaging apparatus 1 according to an embodiment of the present invention, as shown in FIG. 1, has: a control section 11 that controls a whole operation and controls a mask adjustment processing operation, stores a mask adjustment pattern in a storage region; and an operation section 12 that performs operations of supplying power to the control section 11, changing a channel, and controlling a volume. Further, a mask input section 13 having a display section for supplying a masking quantity in an X direction and in a Y direction to the control section 11 at the time of a mask processing operation is removably connected.

Further, the projection type imaging apparatus 1 according to an embodiment of the present invention has: a tuner section 14 that receives and demodulates a broadcast signal of an analog broadcast or a digital broadcast with respect to a terrestrial wave or a satellite wave; a digital processing section 15 that receives an image signal from the tuner section; a driver 20 that receives a control signal from the control section 11, determines intensity of light, and supplies a drive signal to a light 21, the light 21 receiving the drive signal and irradiating light; a digital micro mirror device (DMD) 22 to which an image signal subjected to a mask processing operation is supplied from the digital processing section 15; and a screen section 2 on which picture light irradiated from the DMD is projected.

The DMD is provided as an optical space modulation element that controls an angle of a micro-mirror by an electrostatic force. This DMD is an element that freely controls an angle of a conductive mirror by an electrostatic force generated among a plurality of electrodes.

That is, the light from a light source 21 is irradiated to a mirror device DMD; each of mirror units configuring the mirror device DMD is controlled ON/OFF in accordance with brightness of an image signal; and the reflection light from such each mirror unit is projected on the screen section 2, thereby making it possible to display a picture. In addition, light beams of R (Red), G (Green), and B (Blue) are sequentially irradiated to the mirror device DMD in a time division manner and color reflection light obtained by sequentially controlling ON/OFF the mirror units in response to picture outputs of R, G, and B is projected to the screen section 2, thereby making it possible to display a color picture.

Further, the projection type imaging apparatus 1 according to an embodiment of the present invention has an audio section 23 that receives a voice signal from the tuner section 14, and then, carries out a voice quality processing operation and/or a voice and image processing operation. Further, the digital processing section described previously has: a capture section 16 that properly stores an image signal received from the tuner section 14 or an input terminal; a scaling section 17 that applies a scaling processing operation to that image signal; an IP converter section 18 that carries out an IP conversion or the like of this signal; and a mask processing section 19 for a digital image signal.

In such a configuration, the projection type imaging apparatus 1 according to an embodiment of the present invention selects as a channel, receives and demodulates, by means of the tuner section 14, a broadcast signal responsive to a channel instructed from the operation section 12, and supplies a picture/voice signal to the digital processing section 15. Here, the capture section 16 acquires a given digital picture/voice signal, and then, the scaling section 17 carries out a scaling processing operation in response to a screen. Then, the IP converter section 18 carries out IP conversion, and then, the mask processing section 19 carries out a mask processing operation for a digital image signal, as described later.

The masked image signal is supplied to the DMD 22. On the other hand, the light from the light source 21 is irradiated to the mirror device DMD; each of the mirror units configuring the mirror device DMD is controlled ON/OFF in response to the masked image signal; and the reflection light from such each mirror unit is projected on the screen section 2, thereby making it possible to display a picture.

In addition, light beams of R (Red), G (Green), and B (Blue) are sequentially irradiated to the mirror device DVD in a time division manner and color reflection light obtained by sequentially controlling ON/OFF the mirror units in response to picture outputs of R, G, and B is projected to the screen section 2, thereby making it possible to display a color picture on the screen section 2.

(Mask Processing Operation)

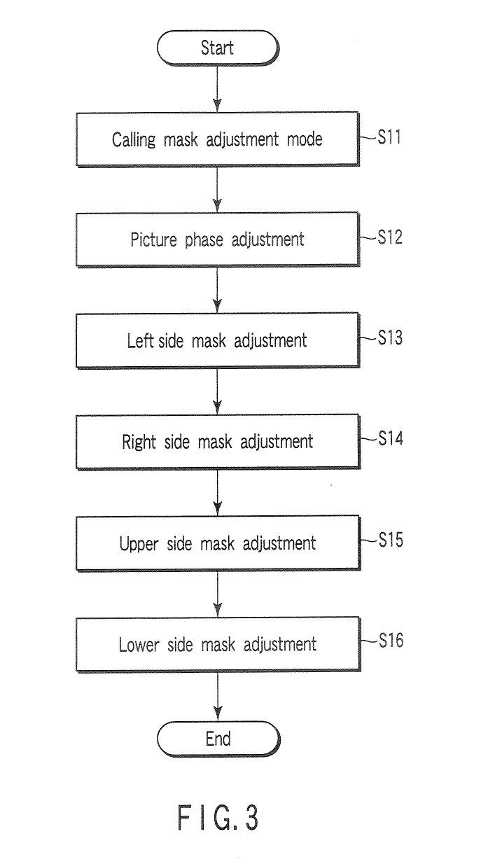

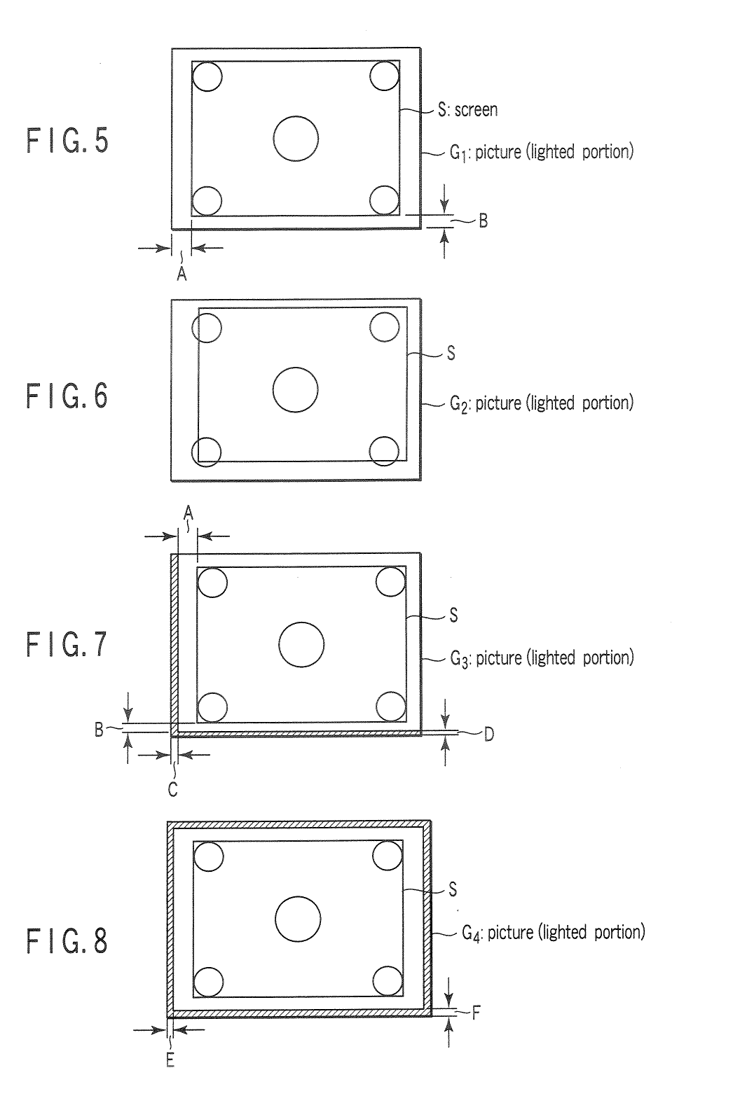

A mask processing operation for a digital image signal according to an embodiment of the present invention will be described in detail with respect to a flow chart shown in FIG. 3, an illustrative view of an optical path shown in FIG. 4, and an illustrative view showing a relationship between a screen section 2 and a picture shown in FIGS. 5 to 8.

In FIG. 3, a mask processing operation for a digital image signal according to an embodiment of the present invention will be described below in detail.

First, in order for a user to carry out a mask processing operation, an operating mode is changed from a normal mode or the like to a mask adjustment mode mainly by an operation of the user (step S11). There is no need for providing settings such that change of this operating mode becomes mandatory. An embodiment in which a mask processing operation can be made even in a normal mode is also preferred.

Then, picture phase adjustment is first performed (step S12). In this adjustment, as shown in FIG. 4, the light from a light 21 that is a light source is irradiated to a DMD 22; picture light that is a reflection light 30 of the irradiated light is irradiated and reflected on a reflection mirror 32 through an objective lens 31; and then, a picture is displayed on the screen section 2.

The picture light produced at this time is not always irradiated to a screen S in an ideal state. FIG. 5 is an illustrative view showing a relationship between a screen and a picture in the case where a mechanical distortion does not occur in a projection type imaging apparatus according to an embodiment of the present invention; and FIG. 6 is an illustrative view showing a relationship between a screen and a picture in the case where a mechanical distortion occurs in a projection type imaging apparatus according to an embodiment of the present invention.

Although picture light is preferably irradiated in a state in which a picture shift due to a mechanical distortion does not occur, as shown in FIG. 5, the picture light is occasionally irradiated in a state in which the picture shift due to the mechanical distortion occurs, as shown in FIG. 6. In such a case, phase correction is carried out in accordance with a processing operation of a scaling section 17, and a state shown in FIG. 7 is established.

A method for making adjustment while varying a panel position is provided as an example of a scaling processing operation. As an example, control is made while start positions and end positions of a side panel, an upper panel, and a lower panel are varied, respectively.

At this time, although regions A and B are permitted ranges in FIG. 7, there is a need for preventing regions C and D from glowing by means of a mask processing operation in order not to affect a picture on the screen S. Therefore, after IP conversion using an IP converter section 18, the regions C and D are subjected to a mask processing operation of a required masking quantity by a mask section 19. In another method, although reflection has been restrained by attaching a black tape to a cabinet on which reflection occurs, in a manufacturing line, this has been wasteful in terms of time and cost efficiency.

Similarly, in FIG. 8, with respect to picture light in a state in which a picture shift due to a mechanical distortion shown in FIG. 5 does not occur, picture light in an optimal state is obtained by applying a mask processing operation to proper mask regions E and F for an over-scan portion.

Here, referring back to the flow chart shown in FIG. 3, after adjusting a picture phase (step S12), as shown in FIGS. 7 and 8, a mask processing operation of a proper mask quantity is carried out. As an example, a left side mask processing operation is carried out (step S13); a right side mask processing operation is carried out (step S14); an upper side mask processing operation is carried out (step S15); and a lower side mask processing operation is carried out (step S16), whereby this procedure is carried out. However, there is no need for observing this sequence, and it is possible to make a mask processing operation in another sequence.

A basic essence of the present embodiment is to eliminate a redundantly glowing portion by masking a redundant picture region and restrain unnecessary reflection to the screen section 2. Another essence of the embodiment is to use IIC bus control for use in factory adjustment. Products for which factory adjustments have been finished are shipped while a mask input section 13 is removed. It is economical to produce and use a small amount of mask input sections 13 or the like with respect to a number of products.

It is also preferable to replace the working of a display section that comes with the mask input section 13 by the screen 2 in accordance with an on screen display (OSD) system. In this case, it is desirable to disable display for a general user by password setting or the like after shipment.

As has been described above, according to the present embodiment, in the case where picture light has been projected on the screen 2 in a state in which an over-scan has been carried out on a wider region than a screen S, the screen is subjected to a mask processing operation in accordance with a mask adjustment mode or the like, thereby making it possible to acquire an optimal picture light state by a low-cost efficient processing operation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A projection type imaging apparatus comprising:
a mask processing section which applies a digital processing operation to a given digital image signal, and carries out a mask processing operation for the digital image signal;
a light emitting section which irradiates light;
a DMD section which irradiates light to a in response to a masked image signal from the mask processing section, thereby converting the light irradiated from the light emitting section to picture light responsive to the digital image signal, and projecting the converted picture light; and
a screen section which receives the picture light from the DMD section, and displays a picture.

2. The projection type imaging apparatus according to claim 1, further comprising: a control section which stores in a storage region a phase adjustment pattern to carry out phase adjustment of the digital image signal, and carries out the phase adjustment of the digital image signal while irradiating the picture light responsive to the phase adjustment pattern to the screen section.

3. The projection type imaging apparatus according to claim 1, further comprising: a control section which provides a maintenance mode to carry out a mask processing operation of the digital image signal, and selects this mode, thereby carrying out a mask processing operation of the mask processing section.

4. The projection type imaging apparatus according to claim 1, wherein the mask processing section carries out a mask processing operation in an x direction and a mask processing operation in a y direction, respectively independently, with respect to the digital image signal.

5. A projection type imaging method comprising:
applying a digital processing operation to a given digital image signal, and carrying out a mask processing operation for the digital image signal to output a masked image signal;
irradiating light in order to irradiate picture light;
adjusting a reflection quantity in response to the masked image signal, thereby converting light from the light emitting section to picture light responsive to the digital image signal, and projecting the converted picture light; and
projecting the picture light on a screen to display a picture.
